(19) United States
(12) Patent Application Publication
(10) Pub. No.: US 2026/0292743 A1
(43) Pub. Date: Sep. 24, 2026

(54) METHODS AND SYSTEMS FOR DETECTING NON-CARRIER SIM USAGE IN CARRIER APPLICATIONS AND PROVIDING TARGETED OFFERS

(71) Applicant: T-Mobile USA, Inc., Bellevue, WA (US)

(72) Inventor: David Bryant Moffett, Issaquah, WA (US)

(21) Appl. No.: 19/087,348

(22) Filed: Mar. 21, 2025

(51) Int. Cl. H04W 60/00; H04W 4/24; H04W 12/06

(52) U.S. Cl. CPC H04W 60/00; H04W 4/24; H04W 12/06

(57) ABSTRACT

Methods and systems for detecting non-carrier SIM usage in carrier application and providing targeted offers utilize a carrier application server and a business unit server to response dynamically to user interactions with a carrier application installed in a user equipment (UE). In an implementation, a user interaction with the carrier application in the UE may trigger an authentication request on the SIM card associated with the UE. When it is determined that the SIM card is not registered to the carrier, the application server may establish a communication channel between the carrier application and the business unit server. Through the communication channel, the business unit server may present dynamic content in various views based at least in part on the user input on those views. The business unit server may further execute a machine learning model to recommend one or more plans and promotions to engage a new customer.

Mobile network carrier offers various services to its subscribers through proprietary applications such as billing, account management, and promotional offers. For example, My Verizon application is provided to Verizon subscribers, T-Life is provided to T-Mobile subscribers, myAT&T application is provided to AT&T subscribers, etc. However, these applications are normally developed to interact primarily with the SIM cards registered to the carrier's own network. There lacks a system to recognize and respond to an interaction from a SIM card registered to a different mobile network carrier.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example scenario, in which methods for detecting non-carrier SIM usage in carrier application and providing targeted offers are implemented according to the present disclosure.

FIG. 2 illustrates another example scenario, in which methods for detecting non-carrier SIM usage in carrier application and providing targeted offers are implemented according to the present disclosure.

FIG. 3 illustrates an example process for detecting non-carrier SIM usage in carrier application and providing targeted offers according to the present disclosure.

FIG. 4 illustrates another example process for detecting non-carrier SIM usage in carrier application and providing targeted offers according to the present disclosure.

FIG. 5 illustrates an example computing device, in which methods for detecting non-carrier SIM usage in carrier application and providing targeted offers are implemented according to the present disclosure.

### DETAILED DESCRIPTION

Techniques for detecting non-carrier SIM usage in carrier application and providing targeted offers are disclosed herein.

In some implementations, a method for detecting non-carrier SIM usage in carrier application and providing targeted offers may be implemented by a computing device associated with a mobile service operator. The computing device may be a carrier application server. In some examples, a server device in a business department of the mobile service operator may be integrated with the carrier application server to respond to non-carrier SIM usage efficiently.

In implementations, a carrier application server may receive, from a user equipment (UE), a signal indicative of an interaction with the carrier application operating on the UE. The carrier application server may determine whether the SIM card associated with the UE is registered to the carrier network. When the SIM card is registered to the carrier network, the carrier application server may present, in the carrier application, information associated with the SIM card. When the SIM card associated with the UE is not registered to the carrier network, the carrier application server may send a request to a business unit server to provide, in the carrier application, information associated with engaging a new customer.

In implementations, the interaction with the carrier application may include one or more of downloading the carrier application to the UE, launching the carrier application on the UE, or attempting to use the carrier application on the UE.

In implementations, the signal, when generated by the UE, may include encrypted SIM card information of the UE. The carrier application server may forward the signal to an authentication server associated with the carrier network. The authentication server may decrypt the signal to obtain the SIM card information and determine whether the SIM card is registered to the carrier network. The authentication server may send a response to the carrier application server to indicate whether the SIM card is registered or not.

In implementations, when the SIM card is not registered to the carrier network, the business unit server may compile data from various resources to generate integration information. The business unit server may present a plurality of views of information in the carrier application to collect personal data, preference data, and any data that may be used to recommend service plans and promotions to a potential new customer. In implementations, the business unit server may re-compile the data based on the user input on a prior view and update the integration data such that information presented in a subsequent view may be more related and/or attractive to the potential new customer.

In implementations, once the potential new customer confirms a subscription and enters billing information, the business unit server may forward the data to a user data management server to create a new subscription and register the SIM card to the carrier network.

In some examples, the SIM card may be a physical card. In yet other examples, the SIM card may be a virtual SIM card. The virtual SIM card may be implemented using computer software.

The present disclosure utilizes the carrier application server and one or more network function elements (e.g., business unit server, authentication server, user data management server, etc.) to quickly detect a non-carrier SIM usage and provide targeted offers to a potential new customer. By presenting dynamic content to a potential new customer, the carrier application server and the business unit server can customize the questions to collect user data and recommend services and promotions that best fit the potential new customer's needs.

The techniques discussed herein may be implemented in a computer network using one or more of protocols including but are not limited to Ethernet, Third Generation (3G), Fourth Generation (4G), 4G Long-Term Evolution (LTE), Fifth Generation (5G), Sixth Generation (6G), other radio access technologies, or any combination thereof wherever carrier aggregation concepts and principles apply. Example implementations are provided below with reference to the following figures.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

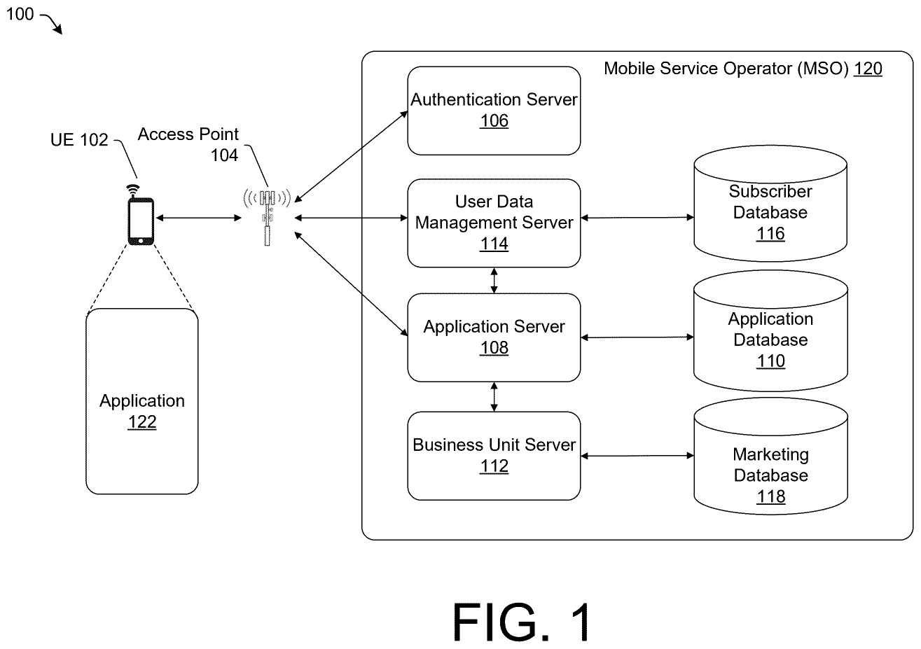

FIG. 1 illustrates an example scenario, in which methods for detecting non-carrier SIM usage in carrier application and providing targeted offers are implemented according to the present disclosure.

Example scenario 100, as illustrated in FIG. 1, may be associated with a network of a mobile service operator (MSO). The user equipment (UE) may attach to a Public Land Mobile Network (PLMN) of the mobile service operator through the access points. As shown in FIG. 1, UE 102 may connect to the network of MSO 120 through access point 104. The UE 102 may be any device that can wirelessly connect to a telecommunication network and may support various radio access technologies such as Bluetooth, Wi-Fi, Global System for Mobile Communications (GSM), Code Division Multiple Access (CDMA), Wideband Code Division Multiple Access (WCDMA), Universal Mobile Telecommunications System (UMTS), 4G/LTE or 5G NR. In some examples, UE 102 may be a mobile phone, such as a smart phone or other cellular phone. In other examples, the UE 102 may be a personal digital assistant (PDA), a media player, a tablet computer, a gaming device, or any other type of computing or communication device. In yet other examples, the UE 102 may include the computing devices implemented on the vehicle including but are not limited to, an autonomous vehicle, a self-driving vehicle, or a traditional vehicle capable of connecting to internet. In yet other examples, the UE 102 may be a wearable device and/or wearable materials, such as a smart watch, smart glasses, clothes made of smart fabric, etc. In further examples, the UE 102 may be a virtual reality or augmented reality goggles or glasses.

In implementations, the access point 104 may be compatible with one or more radio access technologies, protocols, and/or standards, such as 5G NR technology, LTE/LTE Advanced technology, other 4G technology, High-Speed Data Packet Access (HSDPA)/Evolved High-Speed Packet Access (HSPA+) technology, Universal Mobile Telecommunication System (UMTS) technology, Code Division Multiple Access (CDMA) technology, Global System for Mobile Communications (GSM) technology, WiMAX technology, Wi-Fi technology, and/or any other previous or future generation of radio access technology. In some examples, the access point may be a gNB associated with a 5G radio access network (RAN) or an eNB associated with a 4G/LTE RAN. Although not shown, the access point may also be associated with a Second Generation (2G) base station, a Third Generation (3G) NodeBs associated with GSM and CDMA access network, digital subscriber line (DSL) and variations of DSL technology that provide access to desktops, workstations, and/or mainframes, Wi-Fi connections to the user equipment, etc.

In implementations, a user may download the application associated with the MSO 120 to a user equipment, e.g., the UE 102. In some examples, once the application is launched on the UE (e.g., the UE 102) where a SIM card is installed, the UE 102 may automatically generate a signal with encrypted SIM card information. The UE 102 may transmit the signal through the access point 104 to an authentication server 106 in the network of the MSO 120. The authentication server 106 may decrypt the signal to retrieve the SIM card information and determine whether the SIM card is registered to the MSO 120. In some examples, the SIM card information associated with the UE may include but is not limited to, an International Mobile Equipment Identity (IMEI), an International Mobile Subscriber Identity (IMSI), an Integrated Circuit Card Identification (ICCID), a Mobile Equipment Identifier (MEI), an Electric Serial Number (ESN), a Mobile Station International Subscriber Directory Number (MSISDN), etc. Accordingly, one or more pieces of such SIM card information may be decrypted from the signal and compared by the authentication server 106 with stored user data in the subscriber database 116 of the MSO 120 to determine whether the SIM card is registered to the MSO120. For example, after the IMEI is obtained from the decrypted signal, the authentication server 106 may compare the IMEI with stored user data in the subscriber database 116, and determine whether there is a match of the decrypted SIM card information which indicates that the SIM card is registered.

If the SIM card is registered to the MSO 120 (i.e., the user is a verified subscriber), the authentication server 106 may also validate the subscription data associated with the SIM card. An application server 108 may transmit user oriented data to the application installed on the UE 102. In implementations, the application server 108 may obtain application data from an application database 110. The application data may include computer-executable codes to create an application environment in the UE, various versions and/or instances of the computer-executable codes for different types of UE and operating systems, etc. Further, the application server 108 may communicate with a user data management server 114 to obtain user data from a subscriber database 116. The user data may include various types of information associated with an active subscriber account such as user name, MSISDN, mailing address, service usage, billing information, subscription data, device information, user identity data, etc. In some examples, the application server 108 may additionally communicate with a business unit server 112 to obtain marketing/service data from a marketing database118. The marketing/service data may include active service promotions for existing customers, active device promotions for existing customers, etc. The application server 108 may deliver dynamic content to the application installed on the UE 102 based at least in part on the application data obtained from the application database 110, the user data obtained from the subscriber database116, and the marketing/service data obtained from the marketing database118. The user may use the application to create, view, and modify user profile, view service usage, view and pay bills, upgrade the services, etc. If the SIM card is not registered to the MSO 120 (e.g., there is no match of the decrypted SIM card information with the stored user data in the subscriber database 116), the authentication server 106 may respond to the access point 104 that the SIM card is not recognized. The response may be further forwarded to the application 122 on the UE 102. Upon receiving the response, the application server 108 may send a request to the business unit server 112 to acquire the marketing/service data associated with a plurality of services offered to a new customer from the marketing database 118 e. Upon receiving the marketing/service data associated with the plurality of services offered to the new customer, the application server 108 may compile such information to generate integration information and present the integration information in the application installed on the UE 102. In some examples, the application server 108 may present an initial view of the integration information in the application to collect personal data of the new customer. The application server 108 may sequentially present one or more views of the integration information to collect further information based on the user input in a prior view. In some examples, based on the personal data inputted in the initial view, the application server 108 may present a second view in the application, replacing the initial view, to collect user preferences. For example, the personal data may indicate that a potential new customer is a male professional in an age range of 25-35. The application server 108 may include one or more interactive items in the second view, prompting the potential new customer to input and/or select the personal preferences, e.g., video games, streamed movies/TV series, frequent travelers, outdoor activities, etc. Based on the input in the second view, the application server 108 may recompile the information associated with the plurality of services and present one or more recommended services in a third view. For example, the male professional in an age range of 25-35 may indicate that he spends an average of two hours per day in video games. Based on that, the application server 108 may present a service package featuring in unlimited premium data. In another example, a male in an age range of 45-55 may indicate that he spends an average of two hours in streamed movies and TV series. Based on that, the application server may present a service package featuring in Apple TV and Netflix with unlimited premium data. In some examples, if the potential new customer wants to upgrade his/her device, the application server 108 may present a service package with promotions of getting a new device.

In implementations, when the potential new customer selects a recommended service via the application, the application server 108 may further present a view of integration information to facilitate input of billing information, e.g., name, billing address, credit card information, social security number, etc. Once the potential new customer confirms the subscription to the recommended service and inputs the billing information, the application server 108 may send a request to the user data management server 114 to create a user data entry associated with the new subscription in the subscriber database 116 and to register the SIM card of the UE to the MSO 120.

As discussed herein, current carriers'mobile applications are developed primarily for the existing customers to manage user data and pay bills. When a user of a competitor carrier downloads or attempts to use the mobile application in a device, the current carrier system may not be configured to detect the SIM registered through a different network and respond dynamically to the user activities. The present disclosure provides techniques to detect, through a carrier provided mobile application, a SIM card registered to a different carrier, and to further interact with a potential new customer through the mobile application to engage the potential new customer to switch the carriers.

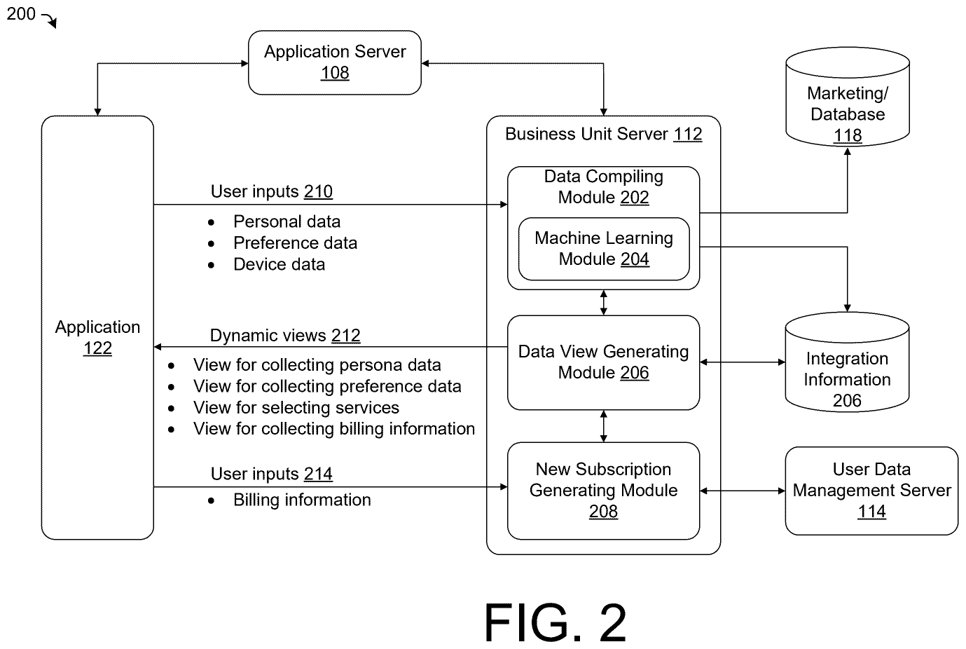

FIG. 2 illustrates another example scenario, in which methods for detecting non-carrier SIM usage in carrier application and providing targeted offers are implemented according to the present disclosure.

As shown in example scenario 200, through the application server 108, the application 122 may communicate with the business unit server 112 and present dynamic content on an interface, facilitating user interactions with the application. The business unit server 112 may include a data compiling module 202, a data view generating module 206, and a new subscription generating module 208. The data compiling module 202 may be configured to compile data from different resources such as user inputs 210 received from a user interface generated by the application 122, the marketing/service data obtained from the marketing database 118, etc., and generate integration information 216 to be presented on the user interface of the application 122. The data view generating module 206 may be configured to generate dynamic views 212 of the integration information 216 on the interface of the application 122. Once a new customer confirms a subscription and provides billing information (e.g., user inputs 214), the new subscription generating module 208 may send a request to the user data management server 114 to create a new subscription record and switch the SIM card to register to the current carrier network.

In implementations, upon determining that the SIM card associated with the user equipment is not registered to the current carrier, the application server 108 may automatically generate a request to the business unit server 112 to establish a communication channel between the application 122 and the business unit server 112. The business unit server 112 may present an initial view of information on the user interface of the application 122 to collect data from a potential new customer. For example, the data view generating module 206 may generate a dynamic view for collecting personal data. The dynamic view for collecting personal data may include one or more interactive items that allow the user to input personal data via the user interface. The data compiling module 202 may analyze the inputted personal data and the marketing/service data, and associate the personal data with candidate service plans and/or promotions. The associated personal data and candidate service plans and/or promotions may be used to update the integration information 216.

The data view generating module 206 may generate a second view for collecting preference data from the potential new customer based on the updated integration information 216. The second view may be presented on the user interface of the application 122, replacing the initial view. In some examples, the second view may replace partial content of the initial view. In some examples, multiple options of the preference data to be selected or answered may be tailored based at least in part on the collected personal data. For example, the data view generating module 206 may provide one or more preferences related to digital device usage based on the age range, the professions, the gender, the language, or the combination thereof. The collected preference data may be further analyzed by the data compiling module 202. As discussed herein, with the preference data, the data compiling module 202 may refine the candidate service plans and/or promotions for the potential new customer. Further, the data compiling module 202 may update the integration information 216 with the preference data and the refined result of the candidate service plans and/or promotions.

In implementations, the data compiling module 202 may execute a machine learning module 204 to determine the candidate service plans and/or promotions. In some examples, the machine learning module 204 may use the personal data as an input and output the candidate service plans and/or promotions. When the preference data is collected, the machine learning module 204 may use one or more of the personal data or the preference data as the input and output the candidate service plans and/or promotions. In some examples, the candidate service plans and/or promotions may be customized for the potential new customer based on at least one of the personal data, the preference data, or the current service plans and/or promotions. In implementations, the machine learning module 204 may be trained using the existing customer data such as, user profile, subscription data, subscription length, service change activities (e.g., upgrading, downgrading, disconnecting), subscriber change activities (e.g., adding a family member), etc. The algorithm to be used for the machine learning model 204 may include supervised learning, unsupervised learning, semi-supervised learning, reinforcement learning, feature learning, sparse dictionary learning, or the combination thereof.

In some examples, once the personal data and the preference data are obtained, the data view generating module 206 may generate a third view based on the updated integration information 216, prompting the user to select the service plans. Based on the user selected service plans, the data view generating module 206 may generate a fourth view, prompting the user to input billing information 214. Once the user confirms the service plans and inputs the billing information 212, the new subscription generating module 208 may forward the confirmed service plans and the billing information 212 to the user management server 114.

As discussed herein, by implementing the data compiling module 202 and the data view generating module 206, the business unit server 112 of a carrier (e.g., the MSO 120) can efficiently respond to a user interaction with the application from a device with a non-registered SIM card. In addition, by using a trained machine learning module 204 to analyze and compile the personal data, the preference data, and the marking/service data, the business unit server 112 can provide dynamic content based on the user input in the application, thus, improving the success rate of engaging the new customer.

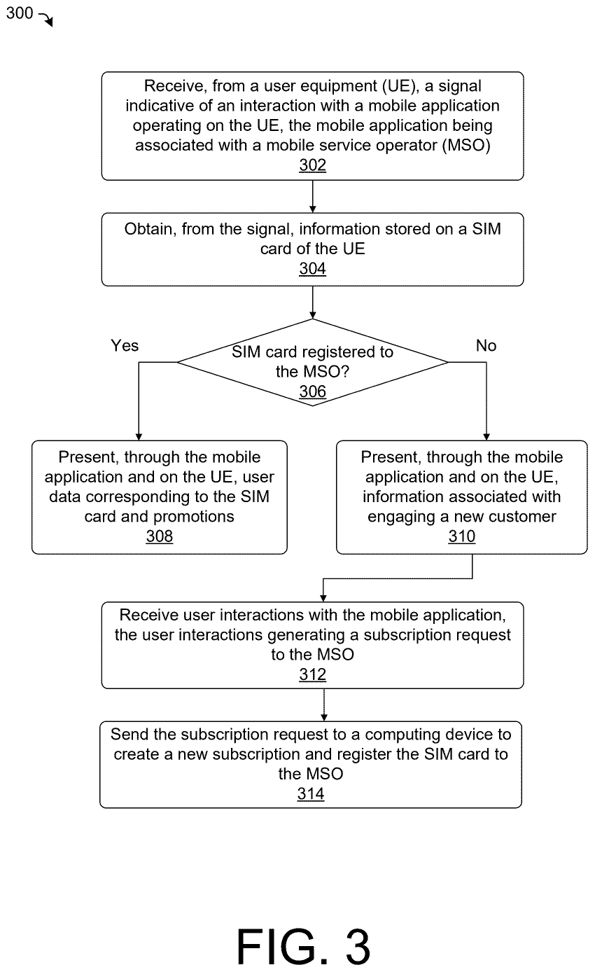

FIG. 3 illustrates an example process for detecting non-carrier SIM usage in carrier application and providing targeted offers according to the present disclosure. The example process 300 may be performed by an application server associated with a carrier, i.e., a mobile service operator (e.g., the application server 108 shown in FIG. 1 and FIG. 2).

At operation 302, the process may include receiving, from a user equipment (UE), a signal indicative of an interaction with a mobile application operating on the UE, the mobile application being associated with a mobile service operator (MSO). In some examples, a downloading of the mobile application to the UE may automatically trigger the signal. In another example, browsing the content of the mobile application, or an attempting to use a feature of the mobile application may also trigger the signal. As discussed herein, the signal generated by the UE, when sent out to an access point, may include encrypted information stored in the SIM card of the UE. The information stored in the SIM card may include an International Mobile Equipment Identity (IMEI), an International Mobile Subscriber Identity (IMSI), an Integrated Circuit Card Identification (ICCID), a Mobile Equipment Identifier (MEI), an Electric Serial Number (ESN), etc.

At operation 304, the process may include obtaining, from the signal, information stored on a SIM card of the UE. In some examples, an authentication server communicatively connected to the application server may decrypt the signal to retrieve the information stored on the SIM card.

At operation 306, the process may include determining whether the SIM card is registered to the MSO. The authentication server (e.g., the authentication server 106 of FIG. 1) may search a subscriber database (e.g., the subscriber database 116) to determine whether there is a match of the decrypted SIM card information. For example, the subscriber database of the first MSO may include identity information associated with an active subscriber account such as user name, MSISDN, device identity data, etc. In such an example, the information obtained from the signal may include an IMEI. Accordingly, the authentication server 106 may compare the IMEI obtained from the signal to IMEIs associated with active subscriber accounts stored in the subscriber database. In this way, if the IMEI obtained from the signal matches a stored IMEI in the subscriber database that is associated with an active subscriber account, the authentication server may determine that there is a match of the decrypted SIM card information. However, in other instances, the authentication server 106 may compare the MSISDN or other device identity data (e.g., IMSI, ICCID, etc.) to data of the same type in the subscriber database that are associated with active subscriber accounts in a similar manner, in order to determine whether there is a match of the decrypted SIM card information.

If there is a match of the decrypted SIM card information, it is determined that the SIM card is registered to the MSO. At operation 308, the process may include presenting, through the mobile application and on the UE, user data corresponding to the SIM card and promotions. As discussed herein, the application server may transmit data associated with the registered SIM card to the application operating on the user equipment. For example, the application server may transmit basic user information (e.g., user profile), subscribed service data, service usage data, active deals or promotions for existing customers, etc. to the application operating on the user equipment.

If there is no match of the decrypted SIM card information, it is determined that the SIM card is not registered to the first MSO. For example, the SIM card may be registered to a different MSO. At operation 310, the process may include presenting, through the mobile application and on the UE, information associated with engaging a new customer. As discussed herein, once a non-MSO SIM card is detected, the application server may send a request to a business unit server to provide information to the potential new customer. Different from providing information to the existing customer, the application server may establish a communication channel to facilitate communications between the application on the user equipment and the business unit server in the mobile service network to provide dynamic content to the potential new customer. In implementations, the business unit server may provide, through the communication channel, a series of views of information to be presented on a user interface generated by the mobile application operating on the user equipment to collect user data. Based on the input in a prior view on the user interface, the business unit server may compile the input with marking/service data to generate integration information customized for the potential new customer.

At operation 312, the process may include receiving user interactions with the mobile application, the user interactions generating a subscription request to the MSO. As discussed herein, the business unit server, by generating the series of views and providing dynamic content, may guide the potential new customer to input any necessary data, and to select an appropriate service plan through the user interface of the mobile application operating on the user equipment. The user interactions with the series of views may further refine the recommended service plans for the potential new customer.

At operation 314, the process may include sending the subscription request to a computing device to create a new subscription and register the SIM card to the MSO. In implementations, once the potential new customer confirms a subscription via an interaction with the application, the application server may send a subscription request to a user data management server such as User Data Management (UDM), to create a new subscription.

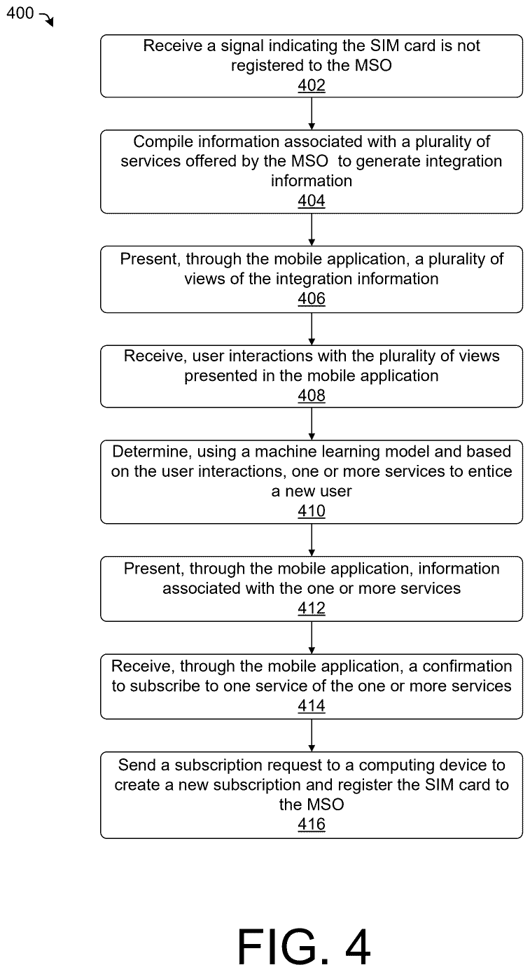

FIG. 4 illustrates another example process for detecting non-carrier SIM usage in carrier application and providing targeted offers according to the present disclosure. The example process 400 may be performed by a business unit server associated with a mobile service operator (e.g., the business unit server 112 shown in FIG. 1 and FIG. 2).

At operation 402, the process may include receiving a signal indicating the SIM card is not registered to the MSO. In some examples, the authentication server may forward the result of authenticating the SIM card directly to the business unit server. In some other examples, the authentication server may send the result to the application server. When receiving the response that indicates the SIM card is not registered to the MSO, the application server may generate a signal to the business unit server, requesting the business unit server to provide information for a potential new customer.

At operation 404, the process may include compiling information associated with a plurality of services offered by the MSO to generate integration information. In implementations, the business unit server may generate the integration information based on data related to current deals and/or promotions for the new customers. For example, the integration information may be generated by combining one or more of the data capacity, voice and text services, streaming applications, device deals, etc. In some examples, the integration information may also include user features related to existing subscriptions, for example, age ranges associated with the services, profession categories associated with the services, genders associated with the services, etc.

At operation 406, the process may include presenting, through the mobile application, a plurality of views of the integration information. In implementations, the business unit server may present an initial view to collect the personal data of the potential new customer on the user interface generated by the mobile application. Based on the personal data, the business unit server may provide a subsequent view on the user interface to collect preference data of the potential new customer. Further, the business unit server may recommend one or more services and/or promotions based at least in part on the personal data and the preference data and present the recommended one or more services and/or promotions on the user interface. Even further, once the potential new customer confirms a subscription, the business unit server may provide a subsequent view to collect billing information. As discussed herein, the business unit server may generate the content to be displayed on the user interface of the application dynamically based on the user input in the prior view.

At operation 408, the process may include receiving user interactions with the plurality of views presented in the mobile application. As discussed herein, the potential new customer may use the application install on the device to input the information. The potential new customer may use a virtual keyboard and/or voice recognition techniques to input the information.

At operation 410, the process may include determining, using a machine learning model and based on the user interactions, one or more services to engage a new user. In some examples, the business unit server may train the machine learning model using training data associated with the existing customers. The training data may indicate various features associated with the subscribed services, for example, an age distribution for video games, gender distribution for video games, profession categories for streaming services, device types for streaming services, etc. The business unit server may use the trained machine learning model to recommend one or more services based on the personal data and the preference data of the potential new customer.

At operation 412, the process may include presenting, through the mobile application, information associated with the one or more services. The information for each of the one or more services may indicate included data capacity, device deals, bundled streaming platforms, voice and text service, roaming options, price of the service plan, etc.

At operation 414, the process may include receiving, through the mobile application, a confirmation to subscribe to one service of the one or more services. As discussed herein, the business unit server may recommend one or more services based on the inputted personal data and preference data. The business unit server may recommend additional serve plans if the potential new customer is not interested in the recommend services. The business unit server may provide additional questions/options in a subsequent view to discover the interest and/or the need of the potential new customer.

At operation 416, the process may include sending a subscription request to a computing device to create a new subscription and register the SIM card to the MSO. Once the potential new customer confirms the subscription, the business unit server may provide the confirmation to the user data management server to process.

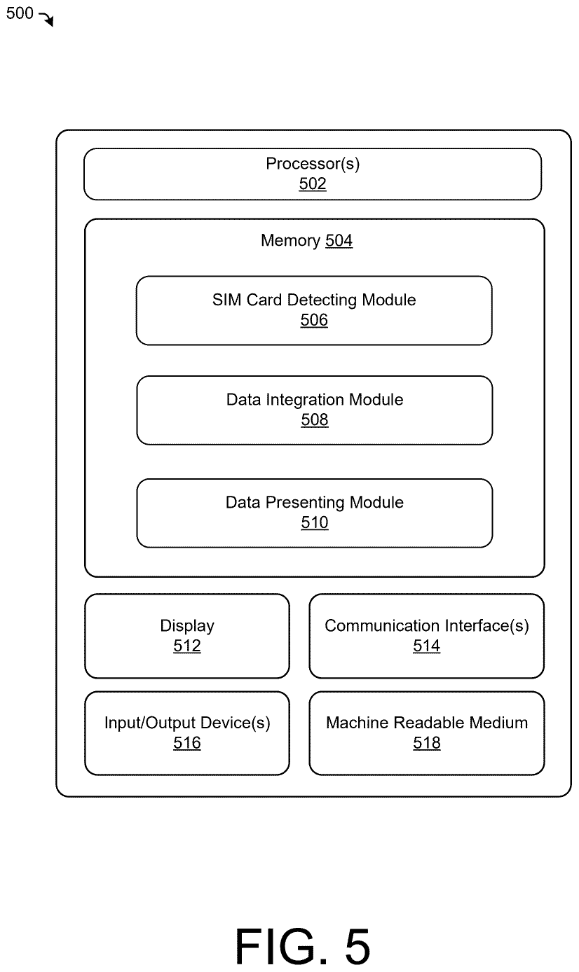

FIG. 5 illustrates an example computing device, in which methods for detecting non-carrier SIM usage in carrier application and providing targeted offers are implemented according to the present disclosure. The example computing device 500 may correspond to a computing server associated with the mobile service operator (e.g., the business unit server 112 shown in FIG. 1 and FIG. 2). In some implementations, the application server 108 may be integrated or operatively coupled to the business unit server 112.

As illustrated in FIG. 5, a computing device 500 may comprise processor(s) 502, a memory 504 storing a SIM card detecting module 506, a data integration module 508, and a data presenting module 510, a display 512, communication interface(s) 514, input/output device(s) 516, and/or a machine readable medium 518.

In various examples, the processor(s) 502 can be a central processing unit (CPU), a graphics processing unit (GPU), or both CPU and GPU, or any other type of processing unit. Each of the one or more processor(s) 502 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 502 may also be responsible for executing all computer applications stored in memory 504, which can be associated with common types of volatile (RAM) and/or nonvolatile (ROM) memory.

In various examples, the memory 504 can include system memory, which may be volatile (such as RAM), non-volatile (such as ROM, flash memory, etc.) or some combination of the two. The memory 504 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 500. Any such non-transitory computer-readable media may be part of the computing device 500.

The SIM card detecting module 506 may be configured to retrieve the information stored in the SIM card such as an International Mobile Equipment Identity (IMEI), an International Mobile Subscriber Identity (IMSI), an Integrated Circuit Card Identification (ICCID), a Mobile Equipment Identifier (MEI), an Electric Serial Number (ESN). The SIM card detecting module 506 may further encrypt the information stored in the SIM card and send it to an authentication server to determine whether the SIM card is registered to the current carrier. The SIM card detecting module 506 may use a key pair (e.g., a public key and a private key) to encrypt the information stored in the SIM card.

The data integration module 508 may be configured to compile data from various resources and generate integration information to be presented to the potential new customer. In some examples, the data present module 510 may present a sequence of views of the integration information on a user interface generated by the application installed on the UE. The inputs on the sequence of views through the user interface may be compiled together with the marketing/service data by the data integration module 508 to dynamically update the integration information. In implementations, the data integration module 508 may use a trained machine learning model to generate customized services for the potential new customer.

The communication interface(s) 514 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the communication interface(s) 514 can be compatible with multiple radio access technologies, such as 5G radio access technologies and 4G/LTE radio access technologies. Accordingly, the communication interface(s) 514 can allow the computing device 500 to connect to the 5G system described herein.

Display 512 can be a liquid crystal display or any other type of display commonly used in the computing device 500. For example, display 512 may be a touch-sensitive display screen and can then also act as an input device or keypad, such as for providing a soft-key keyboard, navigation buttons, or any other type of input. Input/output device(s) 516 can include any sort of output devices known in the art, such as display 512, speakers, a vibrating mechanism, and/or a tactile feedback mechanism. Input/output device(s) 516 can also include ports for one or more peripheral devices, such as headphones, peripheral speakers, and/or a peripheral display. Input/output device(s) 516 can include any sort of input devices known in the art. For example, input/output device(s) 516 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 518 can store one or more sets of instructions, such as software or firmware, which embodies any one or more of the methodologies or functions described herein. The instructions can also reside, completely or at least partially, within the memory 504, processor(s) 502, and/or communication interface(s) 514 during execution thereof by the computing device 500. The memory 504 and the processor(s) 502 also can constitute machine readable medium 518.

The various techniques described herein may be implemented in the context of computer-executable instructions or software, such as program modules, which are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### CONCLUSION

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A computer-implemented method for interacting with a subscriber identity module (SIM) usage in a mobile application, comprising:
receiving, from a user equipment (UE), a signal indicative of an interaction with the mobile application operating on the UE, the mobile application being associated with a mobile network operator;
determining, based on the signal, whether a SIM card associated with the UE is registered to the mobile network operator; and
in response to determining that the SIM card is not registered to the mobile network operator, sending a request to a computing device associated with the mobile network operator, the request causing the computing device to present, in the mobile application operating on the UE, information associated with engaging a new customer.

2. The computer-implemented method of claim 1, wherein the interaction includes at least one of downloading the mobile application to the UE, launching the mobile application on the UE, or attempting to use the mobile application on the UE.

3. The computer-implemented method of claim 1, wherein the signal includes SIM card information, and the computer-implemented method further comprises:
sending the signal to an authentication device associated with the mobile network operator, causing the authentication device to:
obtain, from the signal, the SIM card information;
determine, based at least in part on the SIM card information, whether the SIM card is authenticated,
in response to the SIM card is authenticated, send a response indicating that the SIM card is registered to the mobile network operator, and
in response to the SIM card is not authenticated, send a response indicating that the SIM card is not registered to the mobile network operator.

4. The computer-implemented method of claim 1, wherein the request causes the computing device to:
obtain, from a data storage associated with the mobile network operator, information associated with a plurality of services offered to the new customer;
compile the information associated with the plurality of services to generate integration information; and
present, in the mobile application operating on the UE, a first view of the integration information,
wherein the first view includes a first interactive item facilitating input of personal data.

5. The computer-implemented method of claim 4, wherein the request causes the computing device to:
receive, in the mobile application operating on the UE, the input of the personal data via the first interactive item;
recompile, based on the input of the personal data, the information associated with the plurality of services to update the integration information; and
present, in the mobile application operating on the UE, a second view of the integration information,
wherein the second view replaces the first view and includes:
a recommended service based on the personal data, and
a second interactive item facilitating input of personal preference.

6. The computer-implemented method of claim 5, wherein the request causes the computing device to:
receive, in the mobile application operating on the UE, the input of the personal preference via the second interactive item;
recompile, based on the input of the personal preference, the information associated with the plurality of services to update the integration information; and
present, in the mobile application operating on the UE, a third view of the integration information,
wherein the third view replaces the second view and includes:
a recommended service based on at least one of the personal data or the personal preference, and
a third interactive item facilitating selecting the recommended service.

7. The computer-implemented method of claim 6, wherein the request causes the computing device to:
receive, in the mobile application operating on the UE, the input to select the recommended service via the third interactive item; and
present, in the mobile application operating on the UE, a fourth view of the integration information,
wherein the fourth view replaces the third view and includes:
a fifth interactive item facilitating input of billing information, and
a sixth interactive item facilitating confirmation of subscribing to the recommended service.

8. The computer-implemented method of claim 7, wherein the request causes the computing device to:
receive, in the mobile application operating on the UE, the input of the billing information and the confirmation of subscribing to the recommended service;
create, in a user database associated with the mobile network operator, an entry representing a new subscription to the recommended service; and
register the SIM card of the UE to the mobile network operator.

9. The computer-implemented method of claim 1, further comprising:
in response to determining that the SIM card is registered to the mobile network operator, present, in the mobile application operating on the UE, information associated with the SIM card.

10. A system associated with a mobile network operator, comprising:
a processor; and
a non-transitory computer-readable memory storing computer-executable instructions that, when executed by the processor, cause the processor to perform actions including:
receiving, from a user equipment (UE), a signal indicative of an interaction with a mobile application operating on the UE, the mobile application being associated with the mobile network operator;
determining, based on the signal, whether a SIM card associated with the UE is registered to the mobile network operator; and
in response to determining that the SIM card is not registered to the mobile network operator, sending a request to a computing device associated with the mobile network operator, the request causing the computing device to present, in the mobile application operating on the UE, information associated with engaging a new customer.

11. The system of claim 10, wherein the interaction includes at least one of downloading the mobile application to the UE, launching the mobile application on the UE, or attempting to use the mobile application on the UE.

12. The system of claim 10, wherein the signal includes SIM card information, and the computer-executable instructions, when executed by the processor, cause the processor to perform actions including:
sending the signal to an authentication device associated with the mobile network operator, causing the authentication device to:
obtain, from the signal, the SIM card information;
determine, based at least in part on the SIM card information,
whether the SIM card is authenticated,
in response to the SIM card is authenticated, send a response indicating that the SIM card is registered to the mobile network operator, and
in response to the SIM card is not authenticated, send a response indicating that the SIM card is not registered to the mobile network operator.

13. The system of claim 10, wherein the request causes the computing device to:
obtain, from a data storage associated with the mobile network operator, information associated with a plurality of services offered to the new customer;
compile the information associated with the plurality of services to generate integration information; and
present, in the mobile application operating on the UE, a first view of the integration information,
wherein the first view includes a first interactive item facilitating input of personal data.

14. The system of claim 13, wherein the request causes the computing device to:
receive, in the mobile application operating on the UE, the input of the personal data via the first interactive item;
recompile, based on the input of the personal data, the information associated with the plurality of services to update the integration information; and
present, in the mobile application operating on the UE, a second view of the integration information,
wherein the second view replaces the first view and includes:
a recommended service based on the personal data, and
a second interactive item facilitating input of personal preference.

15. The system of claim 14, wherein the request causes the computing device to:
receive, in the mobile application operating on the UE, the input of the personal preference via the second interactive item;
recompile, based on the input of the personal preference, the information associated with the plurality of services to update the integration information; and
present, in the mobile application operating on the UE, a third view of the integration information,
wherein the third view replaces the second view and includes:
a recommended service based on at least one of the personal data or the personal preference, and
a third interactive item facilitating selecting the recommended service.

16. The system of claim 15, wherein the request causes the computing device to:
receive, in the mobile application operating on the UE, the input to select the recommended service via the third interactive item; and
present, in the mobile application operating on the UE, a fourth view of the integration information,
wherein the fourth view replaces the third view and includes:
a fifth interactive item facilitating input of billing information, and
a sixth interactive item facilitating confirmation of subscribing to the recommended service.

17. The system of claim 16, wherein the request causes the computing device to:
receive, in the mobile application operating on the UE, the input of the billing information and the confirmation of subscribing to the recommended service;
create, in a user database associated with the mobile network operator, an entry representing a new subscription to the recommended service; and
register the SIM card of the UE to the mobile network operator.

18. The system of claim 10, the computer-executable instructions, when executed by the processor, cause the processor to perform actions including:
in response to determining that the SIM card is registered to the mobile network operator, present, in the mobile application operating on the UE, information associated with the SIM card.

19. A computer-readable storage medium storing computer-readable instructions, that when executed by a processor, cause the processor to perform operations comprising:
receiving, from a user equipment (UE), a signal indicative of an interaction with a mobile application operating on the UE, the mobile application being associated with a mobile network operator;
determining, based on the signal, whether a SIM card associated with the UE is registered to the mobile network operator; and
in response to determining that the SIM card is not registered to the mobile network operator, sending a request to a computing device associated with the mobile network operator, the request causing the computing device to present, in the mobile application operating on the UE, information associated with engaging a new customer.

20. The computer-readable storage medium of claim 19, wherein the interaction includes at least one of downloading the mobile application to the UE, launching the mobile application on the UE, or attempting to use the mobile application on the UE.
